(19) United States
(12) Patent Application Publication
(10) Pub. No.: US 2006/0048611 A1
(43) Pub. Date: Mar. 9, 2006

(54) Panel fastening and waterproofing anchor

(75) Inventors: Jeffrey J. Berdin, Whitby (CA); Kevin Thomas Michael Scanlan, Mississauga (CA); So Nguyen Lam, Scarborough (CA)

Correspondence Address: NIKOLAI & MERSEREAU, P.A., 900 SECOND AVENUE SOUTH, SUITE 820, MINNEAPOLIS, MN, 55402, US

(73) Assignee: ILLINOIS TOOL WORKS, Glenview, IL (US)

(21) Appl. No.: 10/935,066

(22) Filed: Sep. 7, 2004

(51) Int. Cl. B25B 13/06; F16B 13/04; F16B 13/06

(52) U.S. Cl. 81/121.1; 411/29; 411/34; 411/55

(57) ABSTRACT

A self-anchoring fastening device for laminating sheets of material such as sheets of metal used in constructing metal buildings. The anchor comprises a collapsible anchoring portion having radially expanding anchoring strips, which will not pull out of a hole drilled in the sheets. Threads internal to the expandable anchor cooperate with threads on a bolt inserted therein to collapse the expandable anchor, providing anchoring strips over one sheet such that the expandable anchor cannot be pulled out of the hole. A washer between the base of the collapsible anchoring portion and one sheet provides for a waterproof fastener such that the building will be watertight. The anchor is easy to install by placing the anchoring device though aligned apertures in two sheets and then turning the bolt relative to the collapsible anchoring portion to extend the radially expanding strips thus securing one sheet to the other.

### BACKGROUND OF THE INVENTION

1. Field of the Invention

This invention relates to self-expanding fasteners, which will not pull out of holes and more particularly for a waterproof way of attaching two sheets of material together particularly for building structures.

2. Description of the Related Art

During the construction of buildings assembled by connecting two sheet of metal or other materials together one method of fastening the sheets together is by providing holes in overlapping sheets and placing a bolt though the hole and then securing the bolt by screwing a nut thereon. This generally requires two people since the sheet of material prevents one person from simultaneously being able to insert the bolt in the hole and reach around to the other side of the sheet to thread the nut on the bolt and then tighten the nut on the bolt while holding the bolt from turning.

In some instances the bolts may not be easy to insert though the holes without interference from the threads on the edge of the sheet aperture impeding the insertion of the bolts and damaging the threads making it harder to screw the nut on the bolt or making it hard to start threading the nut on the bolt.

Often while trying to attach nuts to bolts the alignment is difficult and time consuming and nuts are sometimes dropped before the threading takes hold. This results is wasted parts and dangerous conditions which may cause accidents.

Further a nut attached to a bolt may come loose or fall off the bolt over time. In some instances the position of the nut may not be sufficiently tight on the bolt allowing gaps in the laminated sheets or the pressure on washers on one side of the bolt may not be sufficient to prevent water leaks. A nut may also be overtorqued on a bolt stripping the threads and resulting in a fastening of the wrong pressure on the overlapping materials and perhaps damaging the washer and allowing leaks, or even overstressing or breaking the bolt.

Additionally, in some assembly of structures, heights require the use of ladders by workers on both sides of the sheets, which adds cost of extra equipment required for the job.

Further the strength and integrity of the fastening may be required to be calibrated to a known value for building inspection and end product integrity, which cannot be guaranteed by the use of nuts and bolts.

In many cases prefabricated building materials with holes for the fasteners are provided at the job site however holes may have to be drilled in the building materials on site through one or both overlapping panels. For efficiency the drilling and inserting of the anchor are preferably accomplished in one step.

### SUMMARY OF THE INVENTION

The panel-fastening anchor has two main components, the portion that collapses or mushrooms and a bolt that mechanically causes the collapse.

The mushrooming component has a tubular body with a short section of internal threads on one end and a square flat base on the other end. The tubular portion of the mushrooming component has slits in the sides, and the sides are slightly bowed out to promote symmetrical collapse. The tube is collapsed by a threaded bolt rotated within the tubular body, which pulls the internally threaded section downwards towards the base. The mushrooming anchor when collapsed has radially extended anchoring strips preventing extraction of the fastener from the holes in the sheets through which the fastener extends.

A washer on the bolt prevents water from leaking through the holes in the sheets attached by the panel-fastening and waterproofing anchor.

The bolt may have threads extending a known length which engage threads in the mushrooming component of a known length to collapse the mushrooming component a specified distance corresponding to the width of the two sheets of material to be fastened taking into account the width of the washer and the position of the radially extended anchoring strips to provide the desired force on the sheets and the desired pull out strength of the mushrooming component.

The threads on the bolt are protected by the tube of the tube of the mushrooming body when inserted through the sheets to be fastened such that the threads are protected from damage during insertion and the smooth sides of the tube allow easier insertion through the holes in the sheets of material allowing for easier and faster installation without damaging parts.

The anchor is easy to use by simply placing the device in a socket attached to a drill and turning the socket. The anchor is placed through overlapping holes in sheets of material and an external socket end sleeve tool slides upward over the internal socket engaging the base of the mushrooming component. The exterior sleeve engages the base of the mushrooming component preventing it from rotating. The next step is to turn the bolt with the internal socket while holding the mushrooming component with the external sleeve causing the mushrooming portion of the fastener to collapse.

The expandable anchor provides a known pull out strength which may be necessary for building safety while providing an easy to install method having a fool proof, no stripping, overturning or over torquing feature thus preventing breakage of the fastener which may cause failure and increase construction costs.

In an alternative embodiment a drill bit is placed on one end of the of the bolt or on the top of the anchor to drill a hole in one or both sheets and then the anchor is inserted through the holes in the sheets.

### OBJECTS OF THE INVENTION

It is an object of the invention to provide a self-expanding anchor for sheets of building material.

It is an object of the invention to provide a fastener with exceptionally high pull out strength.

It is an object of the invention to provide a self-expanding anchor, which is easy to install.

It is an object of the invention to insure proper consistent, installation.

It is an object of the invention to provide a one-piece fastener.

It is an object of the invention to provide a fastener, which is quickly installed.

It is an object of the invention to principally use the invention with predrilled holes in sheets of material.

It is an object of the invention to quickly and easily laminate two sheets of material.

It is an object of the invention to provide fasteners with known forces holding the laminated material together at specified material thicknesses.

It is an object of the invention to provide fasteners with waterproof seal fasteners.

It is an object of the invention to drill a hole in at least one of the sheets with a drill bit attached to one end of the panel fastening and waterproofing anchor.

It is an object of the invention to drill a hole and insert the anchor during the same operation.

It is an object of the invention to provide hole alignment in the sheets by drilling one or both holes with a drill bit on the panel fastening and waterproofing anchor.

Other objects, advantages and novel features of the present invention will become apparent from the following description of the preferred embodiments when considered in conjunction with the accompanying drawings.

### BRIEF DESCRIPTION OF THE DRAWINGS

FIG. 1 is an exploded perspective view of the collapsible mushrooming portion, threaded bolt with washer attached, and the associated sockets, sleeve tools and socket extensions for operating the expandable anchor.

FIG. 2 is a cut-a-way expanded side view of the expandable anchor with a drill bit on the top of the mushrooming component, a socket, drive shaft extension and sleeve tool before installation of the mushrooming expandable anchor.

FIG. 3. is a cut-a-way expanded side view of the expandable anchor with a drill bit on the tip of the bolt, a socket, drive shaft extension and sleeve tool after installation of the mushrooming expandable anchor.

FIG. 4 is a perspective view of a sleeve tool with notches of the mushrooming component base, socket, collapsible mushroom portion, threaded bolt, and a mushrooming expandable anchor.

FIG. 5 is a perspective view of a sleeve tool with a handle and a depression for the mushrooming component base, socket, collapsible mushroom portion, threaded bolt, and a mushrooming expandable anchor.

FIG. 6 is a top view of the sleeve tool with a handle and a depression for the mushrooming component base.

FIG. 7 is a top view of the handle for the sleeve tool.

### DESCRIPTION OF THE PREFERRED EMBODIMENTS

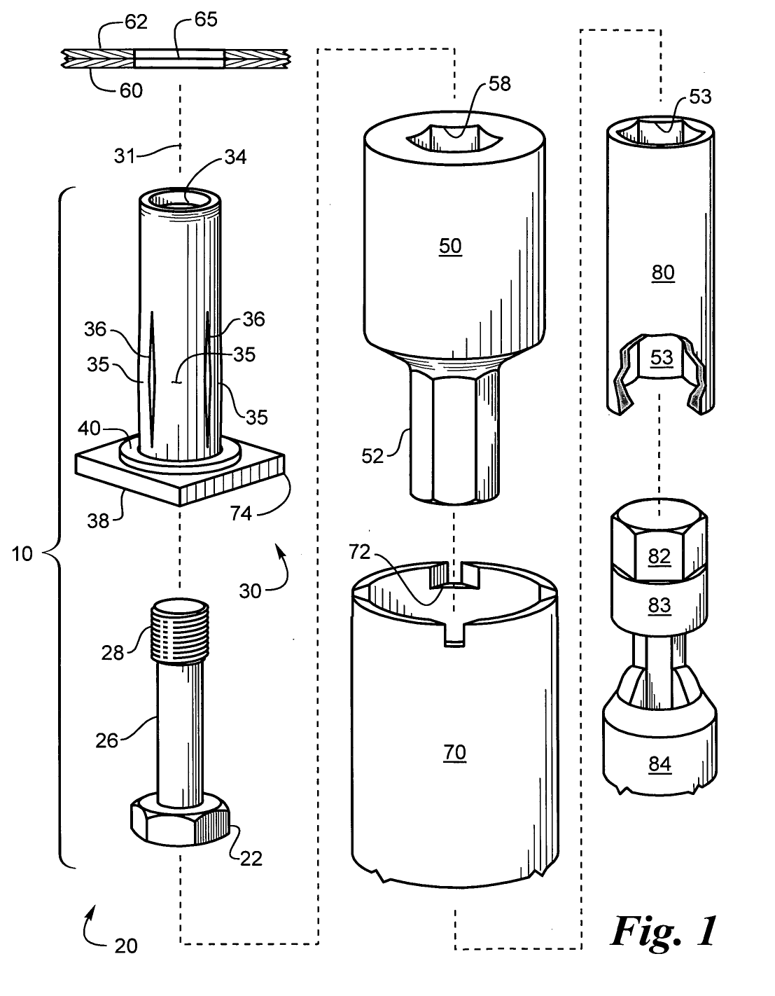

FIG. 1 shows the mushrooming expandable anchor 10 unassembled. In a first embodiment the mushrooming expandable anchor 10 has three component parts. A bolt 20, a mushrooming component 30 similar to AVK Industrial Products A-R Series™ Threaded Insert, sold by AVK Industrial Products of Valencia, Calif., and washer 40. FIG. 1 also shows tools used to install the mushrooming expandable anchor 10. The tools include a socket 50 for turning the hex head bolt 20, a sleeve tool 70 for engaging the expandable anchor 30, an internally broached drive shaft 80 for engaging the socket 50, and a drive tool/adaptor 83 having a hex adaptor portion 82 to turn the above described assembly.

In a first embodiment, as shown in FIG. 1, apertures 65 in sheets 60 and 62 are aligned and have a slightly larger diameter than the mushrooming component 30 such that it allows the mushrooming portion 35 of the mushrooming component 30 to fit though the apertures 65.

The mushrooming component 30 is basically a cylinder having an internal threaded portion 34 near the top and a base 38 at the bottom. Slots 36 are cut thought the cylinder walls in several locations around the mushrooming component 30 so that it can be compressed and split apart along the slits to form anchoring strips 37 when the mushrooming component 30 is collapsed as shown in FIG. 3. The mushrooming component 30 is formed with a bulge 35 in the walls to facilitate the collapse of anchoring strips 37. Although mushrooming component 30 is shown as a cylindrical body 35 with a circular cross section in the figures it can be any shape with any cross section such as an octagon, hexagon, square, or oval etc., as long as it will fit through the apertures 65 and collapse as shown herein.

The bolt 20 has a hex head portion 22, and a bolt shaft 26 having a diameter just smaller than the inside threaded diameter 34 of the mushrooming component 30. The shaft 26 has a threaded section 28 on the top portion for engaging the threads 34 in the mushrooming component 30. Alternatively the bolt 20 may have threads 28 along the entire length of the bolt.

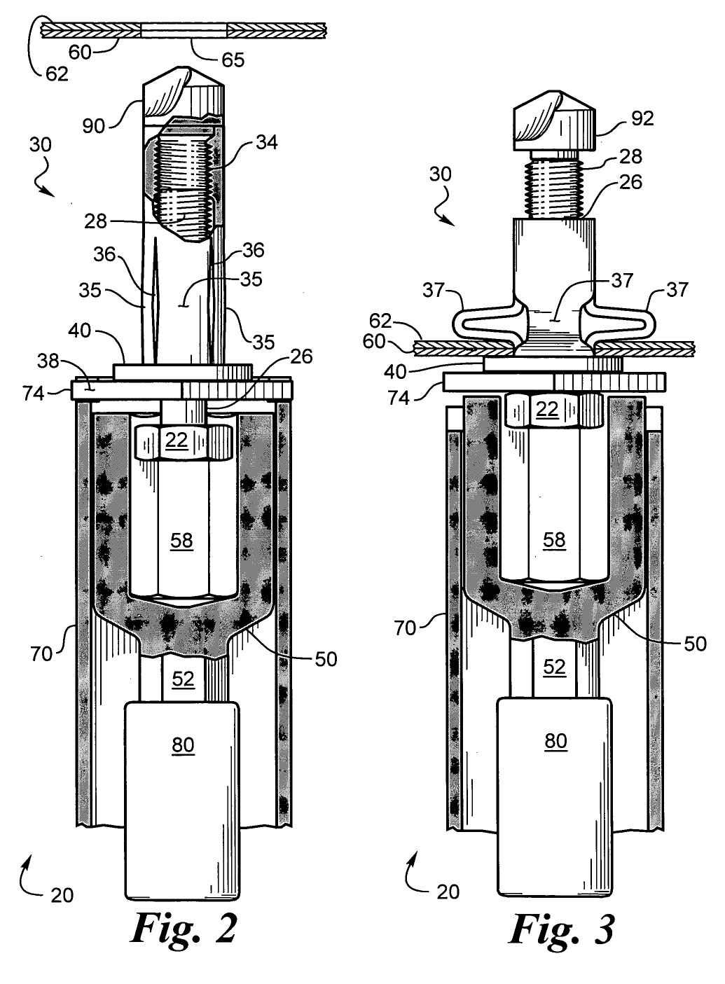

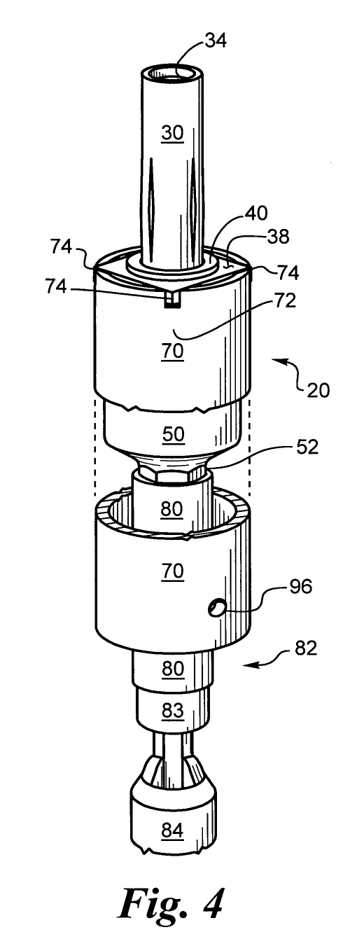

In one mode of use, as seen in FIGS. 2 and 3, the inside threads 34 in mushrooming component 30 are threaded onto the threads 28 on the bolt shaft 26 of hex head bolt 20 by a few turns. The hex head bolt 20 head portion 22 is placed in a socket 50 having a hexagon wall 58 on a portion of the inside surface for mating with the hex head portion 22 of hex head bolt 20. The hex head bolt 20 can then be turned by the socket 50.

The sleeve tool 70 has an inside diameter which fits over the outside diameter of the socket 50 such that the socket 50 can rotate inside the sleeve tool 70 when desired. The sleeve tool 70 has notches 72 for engaging the corners 74 of the base 38 of the mushrooming component 30. The corners 74 on base 38 extend radially out from the central axis 31 of the mushrooming component 30 than the socket 50 to allow sleeve tool 70 to engage the corners 74. Sleeve tool 70 can be a hand held tool on the order of 12 to 15 inches long. The sleeve tool 70 may have a handle 94 to hold it in place while the socket 50 is being turned therein. The handle 94 may be removably attached to the sleeve tool 70 by knobs 95 on the handle 94 inserted into apertures 96 on the sleeve tool 70.

The socket 50 has a hex shaft 52 for connection to internally broached drive shaft 80 which allows connection to machined part 83 having a hex adapter portion 82, as seen in FIG. 1. A driving means 84 such as an electric or battery operated drill, air powered drill or the like can rotating the assembly.

As seen in FIG. 2 the driving means 84 will turn the mushrooming component 30 to collapse or mushroom the mushrooming component 30, as seen in FIG. 3 to secure it from being pulled out of the aperture 65. The driving means 84 will rotate the combination of socket 50 and drive shaft 80 while the installer is holding the sleeve tool 70 in a fixed position such as by handle 94 so that the hex head bolt 20 can rotate relative to the mushrooming component 30 thus rotating the threads 28 of the bolt 20. As best seen in FIG. 1 the threads 28 are only on a portion of the top of the bolt shaft 26. The internal threaded portion 34 of the mushrooming component 30 is also only on a top portion of the mushrooming component 30. The relative length of the threaded portions 28 and 34 on the bolt shaft 26 and the mushrooming component 30 respectively are such that as the hex head bolt 20 is turned relative to the mushrooming component 30 the top of the mushrooming component 30 will be pulled downward allowing the bowed portion 35 having the slots 36 to collapse, forming anchoring strips 37 as seen in FIGS. 3 and 7. Base 38 will be pulled up against the washer 40, which in turn is forced against the sheet 60 to prevent water from entering aperture 65. As the hex head bolt 20 is turned relative to the mushrooming component 30 the anchoring strips 37 will be flattened out. The anchoring strips 37 will not fit through the aperture 65 offering a pull out strength strong enough to securely laminate the sheets 60 and 62.

The lengths of the threaded portions 28 and 34 on the bolt shaft 26 and the mushrooming component 30 respectively are such that the threads 28 on the bolt shaft 26 will exit the top threads 34 on the mushrooming component 30 allowing the hex head bolt 20 to spin freely thereafter when the expandable anchor 10 is compressed to the desired amount taking into account the thicknesses of the sheets 60, 62 and washer 40. This spin free feature eliminates possible over torque or fracture of components incorporated in fastener 10 and presses the washer 40 between the base 38 and the sheet 60 with sufficient force to prevent leakage.

If the threads on bolt 20 are along the entire shaft the bolt 20 is tightened until it is firmly in place and then the blot is not turned any further.

Using the mushrooming expandable anchor 10 two sheets of material such as 16 gauge metal sheets can be laminated to build a metal structure quickly with less labor since only one man is needed on one side of the sheets of material to insert the mushrooming expandable anchor 10 in the apertures 65 and then turn the bolt 20 to collapse the mushrooming component 30 thus securing the sheets 60, 62 together. Since the threads 28 on bolt 20 are secured in the mushrooming component 30 the mushrooming expandable anchor 10 is easily inserted in apertures 65 without the threads engaging the aperture which may impede insertion and possibly damage threads 28.

The anchoring strips 37 may be engineered to have a known pull out strength related to the needs of the construction using sheets 60 and 62 in construction to withstand desired loads.

Various sockets 50 and sleeve tools 70 may be used in conjunction with driving means 84 such as electric drills and other hand held tools.

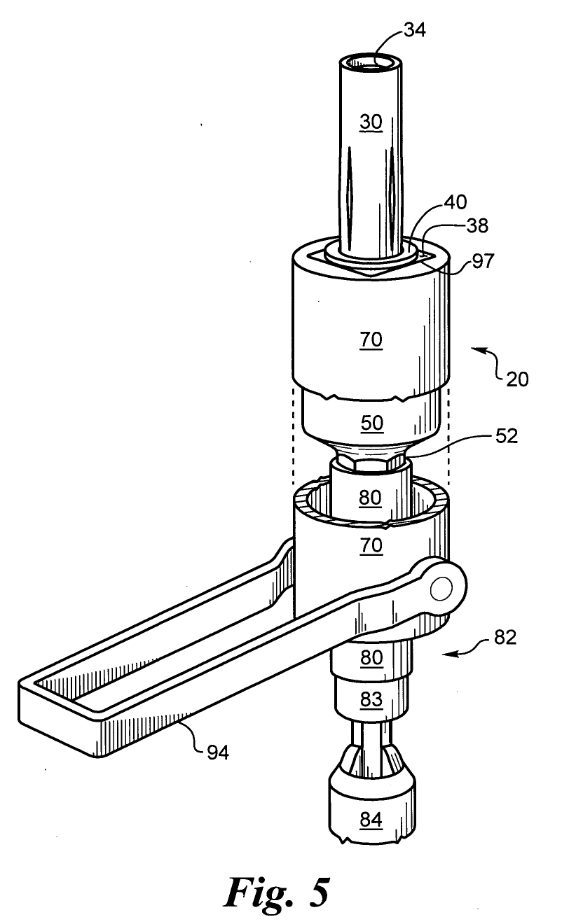

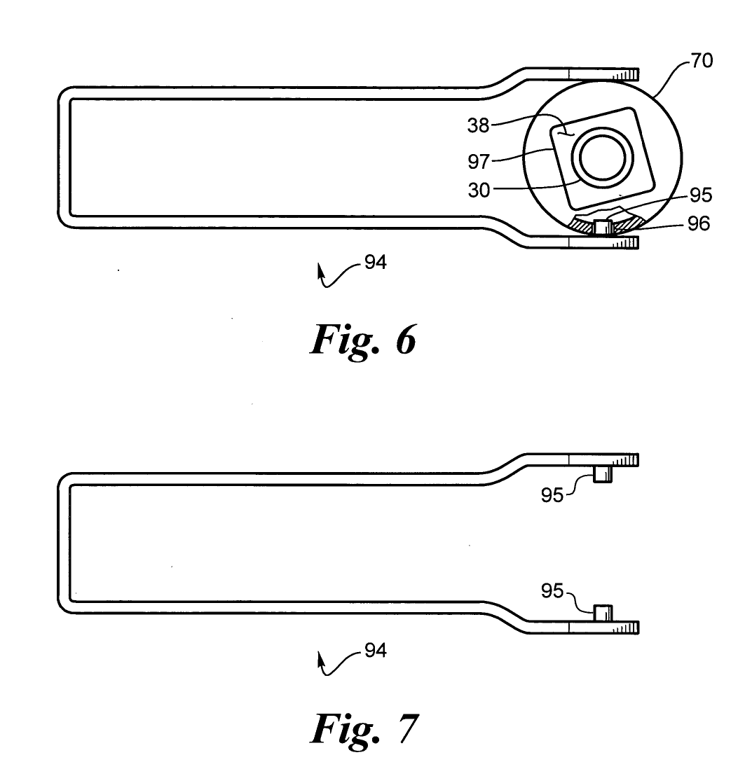

In an alternative embodiment as shown in FIGS. 5 and 6. The base 38 of the mushrooming component 30 is square fits into a square depression 97 in the top of sleeve tool 70 to keep the mushrooming component 30 from spinning relative to the bolt 30 as the bolt is screwed into the mushrooming component 30. Although a square shape has been illustrated any shape may be used to perform the function.

In another embodiment as shown in FIG. 2 the top of the mushrooming component 30 can be fitted with a drill tip for drilling holes in one or more sheets of material 60, 62 just prior to inserting the mushrooming component through aperture 65. In this embodiment the drill bit 90 is turned by turning the base 38 of the mushrooming component 30 with sleeve 70 to drill a hole while bolt 20 spins in unison with mushrooming component 30. Drill bit 90 is attached to the top of the mushrooming component but is expelled by being pushed up and out of the mushrooming component when bolt 20 is turned collapsing the mushrooming component. Alternatively, as shown in FIG. 3 drill bit 92 may be attached to the tip of bolt 20 and used to drill holes in sheets 60, 62 by turning bolt 20 with socket 50 while mushrooming component 30 spins in unison with bolt 30.

Obviously, many modifications and variations of the present invention are possible in light of the above teachings. It is therefore to be understood that, within the scope of the appended claims, the invention may be practiced otherwise than as specifically described.

What is claimed is:

1. an expandable anchor comprising:
a threaded component having, a shaft with threads and a head with a shaped perimeter for tool engaging portion for engaging a socket,
a mushrooming component having a base, a longitudinal body with an internally threaded portion, the longitudinal body having slits for forming radial anchoring strips when the body is longitudinally compressed such that turning the threaded component relative to the mushrooming component while their respective threads are engaged, longitudinally compresses the slitted longitudinal body of the mushrooming component, and
a washer surrounding the longitudinal body adjacent the base.

2. An expandable anchor as in claim 1 wherein,
the base of the mushrooming component has a larger diameter than the head of the threaded component.

3. An expandable anchor as in claim 2 having,
a socket,
a sleeve surrounding the socket and engaging the mushrooming component such that the socket can turn within the sleeve.

4. An expandable anchor as in claim 1 wherein,
the threaded component threads and the mushrooming component threads extend a desired length to mutually engage such that the mushrooming portion collapses a known length and then spin freely relative each other.

5. An expandable anchor as in claim 3 wherein,
the threaded component threads and the mushrooming component threads extend a desired length to mutually engage such that the mushrooming portion collapses a known length and then spin freely relative each other.

6. An expandable anchor as in claim 3 wherein,
the sleeve has a handle for holding the sleeve.

7. An expandable anchor as in claim 1 wherein,
mushrooming component has a drill bit at the tip.

8. An expandable anchor as in claim 1 wherein,
the threaded component has a drill bit at the tip.

9. An expandable anchor comprising,
a mushrooming component having a longitudinal body with an internally threaded portion, the body having slits therein for forming radial anchoring strips when the body is longitudinally compressed, and a flange at one end, and;
a threaded component having a longitudinal body with external threads for engaging the internal threads of the mushrooming component, and a head for turning the threaded component relative to the mushrooming component to longitudinally compresses the longitudinal portion of the mushrooming component, and
a washer on the mushrooming component adjacent the flange.

10. An expandable anchor as in claim 9 wherein,
the threaded component threads and the mushrooming component threads extend a desired length to mutually engage such that the mushrooming portion collapses a known length and then spin freely relative each other.

11. An expandable anchor as in claim 10 having,
a socket for engaging and turning the threaded component.

12. An expandable anchor as in claim 11 having,
a sleeve for surrounding the socket and engaging the mushrooming portion such that the socket can turn independently within the sleeve.

13. An expandable anchor as in claim 9 wherein,
a stabilizing tool for engaging the mushrooming component.

14. An expandable anchor as in claim 13 wherein,
a handle on the stabilizing tool for holding the stabilizing tool.

15. An expandable anchor as in claim 9 wherein,
mushrooming component has a drill bit at the tip.

16. An expandable anchor as in claim 9 wherein,
the threaded component has a drill bit at the tip.
